(19) United States
(12) Patent Application Publication
(10) Pub. No.: US 2026/0211133 A1
(43) Pub. Date: Jul. 23, 2026

(54) ENERGY CORRECTION FOR POSITRON EMISSION TOMOGRAPHY ELECTRONICS USING DIGITALLY CONTROLLED INTEGRATION TIME

(71) Applicant: CANON MEDICAL SYSTEMS CORPORATION, Tochigi (JP)

(72) Inventors: Kent BURR, Vernon Hills, IL (US); Yi QIANG, Vernon Hills, IL (US)

(73) Assignee: CANON MEDICAL SYSTEMS CORPORATION, Tochigi (JP)

(21) Appl. No.: 19/030,121

(22) Filed: Jan. 17, 2025

(51) Int. Cl. G01T 1/29; G01T 7/00

(52) U.S. Cl. CPC G01T 1/2985; G01T 7/005

(57) ABSTRACT

A method of performing an energy correction of positron emission tomography (PET) photodetector signals, including integrating an acquired photodetector signal over an integration window to determine an energy of the acquired photodetector signal; determining an arrival time of the acquired photodetector signal based on a first digital clock having a first clock frequency; determining a relative phase of the determined arrival time with respect to a second digital clock having a second clock frequency; and correcting the determined energy of the acquired photodetector signal based on one or more calibration parameters and the determined relative phase of the arrival time to determine a corrected energy of the acquired photodetector signal, wherein the one or more calibration parameters are determined in a calibration process using a plurality of collected photodetector events.

### BACKGROUND

### Technical Field

The present disclosure relates to integration of photodetector signals.

### Description of the Related Art

Positron emission tomography (PET) is a functional imaging modality that is capable of imaging biochemical processes in humans or animals through the use of radioactive tracers. In PET imaging, a tracer agent is introduced into the patient to be imaged via injection, inhalation, or ingestion. After administration, the physical and bio-molecular properties of the agent cause it to concentrate at specific locations in the patient's body. The actual spatial distribution of the agent, the intensity of the region of accumulation of the agent, and the kinetics of the process from administration to its eventual elimination are all factors that may have clinical significance.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction and are not intended to limit the scope of the following claims. The described embodiments, together with further advantages, will be best understood by reference to the following detailed description taken in conjunction with the accompanying drawings.

In one embodiment, the present disclosure is related to a method of performing an energy correction of positron emission tomography (PET) photodetector signals, the method comprising integrating an acquired photodetector signal over an integration window to determine an energy of the acquired photodetector signal; determining an arrival time of the acquired photodetector signal based on a first digital clock having a first clock frequency; determining a relative phase of the determined arrival time with respect to a second digital clock having a second clock frequency; and correcting the determined energy of the acquired photodetector signal based on one or more calibration parameters and the determined relative phase of the arrival time to determine a corrected energy of the acquired photodetector signal, wherein the one or more calibration parameters are determined in a calibration process using a plurality of collected photodetector events.

In one embodiment, the present disclosure is related to a positron emission tomography (PET) apparatus, comprising a first digital clock having a first clock frequency; a second digital clock synchronized with the first digital clock and having a second clock frequency greater than the first clock frequency; and processing circuitry configured to integrate an acquired photodetector signal over an integration window to determine an energy of the acquired photodetector signal, determine an arrival time of the acquired photodetector signal based on the first digital clock, determine a relative phase of the determined arrival time with respect to the second digital clock, and correct the determined energy of the acquired photodetector signal based on one or more calibration parameters and the relative phase of the arrival time to generate a corrected energy of the acquired photodetector signal, wherein the one or more calibration parameters are determined in a calibration process using a plurality of collected photodetector events.

In one embodiment, the present disclosure is related to a non-transitory computer-readable storage medium for storing computer readable instructions that, when executed by a computer, cause the computer to perform a method, the method comprising receiving a determined energy of an acquired photodetector signal and an arrival time of the acquired photodetector signal based on a first digital clock having a first clock frequency; determining a relative phase of the arrival time with respect to a second digital clock having a second clock frequency; and correcting the determined energy of the photodetector signal based on one or more calibration parameters and the relative phase of the photodetector signal to determine a corrected energy of the photodetector signal, wherein the one or more calibration parameters are determined in a calibration process using a plurality of collected photodetector events.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic of PET detector circuitry, according to one embodiment of the present disclosure;

FIG. 2 is a timing diagram of photodetector signal integration, according to one embodiment of the present disclosure;

FIG. 3 is an illustration of photodetector signal integration time, according to one embodiment of the present disclosure;

FIG. 4A is a histogram of photodetector signal energy, according to one embodiment of the present disclosure;

FIG. 4B is a histogram of photodetector signal energy, according to one embodiment of the present disclosure;

FIG. 4C is a histogram of photodetector signal energy, according to one embodiment of the present disclosure;

FIG. 4D is a histogram of photodetector signal energy, according to one embodiment of the present disclosure;

FIG. 4E is a histogram of photodetector signal energy, according to one embodiment of the present disclosure;

FIG. 5 is an illustration of a relationship between relative phase and photodetector signal energy peak position, according to one embodiment of the present disclosure;

FIG. 6 is an illustration of a relationship between relative phase and integration time, according to one embodiment of the present disclosure;

FIG. 7A is a histogram of corrected photodetector signal energy, according to one embodiment of the present disclosure;

FIG. 7B is a histogram of corrected photodetector signal energy, according to one embodiment of the present disclosure;

FIG. 7C is a histogram of corrected photodetector signal energy, according to one embodiment of the present disclosure;

FIG. 7D is a histogram of corrected photodetector signal energy, according to one embodiment of the present disclosure;

FIG. 7E is a histogram of corrected photodetector signal energy, according to one embodiment of the present disclosure;

FIG. 8 is an illustration of energy resolution of corrected and uncorrected integration, according to one embodiment of the present disclosure;

FIG. 9 is an illustration of a relationship between relative phase transition point and energy resolution, according to one embodiment of the present disclosure;

FIG. 10 is an illustration of a relationship between relative phase transition point and an inverse function, according to one embodiment of the present disclosure;

FIG. 11 is a schematic of PET detector circuitry, according to one embodiment of the present disclosure;

FIG. 12 is a timing diagram of photodetector signal integration, according to one embodiment of the present disclosure;

FIG. 13A is an illustration of photodetector signal integration, according to one embodiment of the present disclosure;

FIG. 13B is an illustration of photodetector signal integration, according to one embodiment of the present disclosure;

FIG. 13C is an illustration of photodetector signal integration, according to one embodiment of the present disclosure;

FIG. 14A is a histogram of photodetector signal energy, according to one embodiment of the present disclosure;

FIG. 14B is a histogram of photodetector signal energy, according to one embodiment of the present disclosure;

FIG. 14C is a histogram of photodetector signal energy, according to one embodiment of the present disclosure;

FIG. 14D is a histogram of photodetector signal energy, according to one embodiment of the present disclosure;

FIG. 14E is a histogram of photodetector signal energy, according to one embodiment of the present disclosure;

FIG. 15 is an illustration of a relationship between relative phase and photodetector signal energy peak position, according to one embodiment of the present disclosure;

FIG. 16 is an illustration of a relationship between relative phase and delay, according to one embodiment of the present disclosure;

FIG. 17A is a histogram of corrected photodetector signal energy, according to one embodiment of the present disclosure;

FIG. 17B is a histogram of corrected photodetector signal energy, according to one embodiment of the present disclosure;

FIG. 17C is a histogram of corrected photodetector signal energy, according to one embodiment of the present disclosure;

FIG. 17D is a histogram of corrected photodetector signal energy, according to one embodiment of the present disclosure;

FIG. 17E is a histogram of corrected photodetector signal energy, according to one embodiment of the present disclosure;

FIG. 18 is an illustration of energy resolution of corrected and uncorrected integration, according to one embodiment of the present disclosure;

FIG. 19 is a flowchart of a method for photodetector signal energy correction, according to one embodiment of the present disclosure;

FIG. 20A shows a perspective view of a PET scanner that can be used with the techniques described herein, according to one embodiment of the present disclosure; and

FIG. 20B shows a schematic view of a PET scanner that can be used with the techniques described herein, according to one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The system may be otherwise oriented (rotated 90 degrees or at other orientations) and the spatially relative descriptors used herein may likewise be interpreted accordingly.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, the present disclosure is directed to integration of signals generated by photodetectors in a positron emission tomography (PET) system. Photodetectors (or photosensors) in a PET system can generate an analog output signal (“photodetector signal”) based on gamma ray interactions with the detector crystals. In one embodiment, the photodetector signal can be a current pulse corresponding to a detected gamma photon generated by an annihilation event. The photodetector signal can be processed and converted to a digital signal that can be used for coincidence detection.

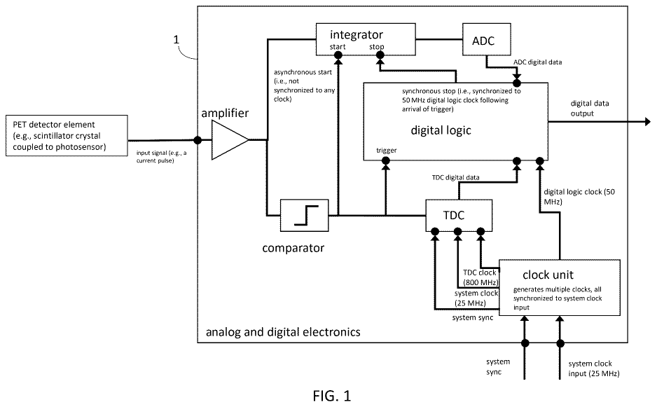

FIG. 1 is a schematic of a data acquisition (DAQ) circuitry unit 1 of a PET system, according to one embodiment. The DAQ circuitry 1 illustrated in FIG. 1 can be used to process a single input system from a photodetector. A PET system can include more than one photodetector. In one embodiment, a PET system can include more than one DAQ circuitry unit 1 to process data from a group of photodetectors. The DAQ circuitry 1 can include analog and digital electronics and can integrate the (analog) photodetector signal over time and convert the integrated value to a digital output using the analog-to-digital converter (ADC). As an analog signal, the current pulse(s) generated by the photodetector can have a gradual rise and fall. The total energy delivered by the current pulse can correspond to the number of photons detected by the photodetector and can be determined by integrating the current pulse over time. The energy resolution and accuracy of a PET system can be dependent on the time window over which the current pulse is integrated. In particular, it can be important to trigger integration promptly in order to capture the rising “edge” and subsequent peak of the signal, which can include a large portion of the total energy delivered by the pulse. It is also important for the integration window to be consistent in duration across all signals.

In one embodiment, the photodetector signal can be amplified prior to integration. The amplified photodetector signal can then be integrated by an integrator. The integrator can be triggered to begin integration when the photodetector signal exceeds a threshold as determined by a comparator. The comparator can generate a digital pulse (“initiation signal,” “initiation pulse”) to trigger the integrator based on the amplitude of the photodetector signal. The initiation signal can be a sharp-edged pulse, such as a square wave. In this manner, the comparator can trigger asynchronous integration to begin when the photodetector signal is received.

In one embodiment, the DAQ circuitry 1 can include digital logic circuitry. The digital logic circuitry can synchronize components of the DAQ circuitry 1 and can control the integrator. The digital logic circuitry can be clocked by a digital logic clock. In one embodiment, the integration window can be a set number of clock cycles. For example, the integrator can integrate the photodetector signal for six full clock cycles (periods) following the initiation signal received from the comparator. In an embodiment wherein the digital logic clock is a 50 MHz clock, the integration window can be approximately 120 ns. The digital logic circuitry can transmit a digital pulse (“termination signal,” “termination pulse”) to the integrator after the set number of clock cycles to terminate integration.

The time-to-digital converter (TDC) can record the arrival time of the rising edge of the initiation signal from the comparator as a digital timestamp. In one embodiment, the TDC can use a TDC clock to generate the digital timestamp. When the TDC clock is a high-speed clock that is faster than the system clock (e.g., 800 MHz TDC clock and 25 MHz system clock), the digital timestamp can be a “fine” timestamp that has greater time resolution than the system clock. In one embodiment, the timestamp can be a count of the number of elapsed clock cycles following an initial synchronization signal. In one embodiment, the timestamp can include a fractional clock period when the initiation signal is received between rising edges of the TDC clock. The fractional clock period can be calculated via the Vernier method, wherein the timestamp is interpolated as a fraction by measuring a time difference between the rising edge of the initiation signal and the next rising edge of the TDC clock.

The DAQ circuitry 1, including the integrator, can be driven by one or more clocks. Clocks having different frequencies can drive different components of the DAQ circuitry 1, as illustrated in FIG. 1. The one or more clocks can be synchronized with a system clock input. For example, phase relationships between the one or more clocks can be synchronized along with the system clock. In one embodiment, the one or more clocks can be derived from a system clock input using a phase-locked loop (PLL) so that the phases of the clocks are fixed and in sync with each other. The frequencies of the one or more clocks can be multiples of the system clock. In one embodiment, the system clock input can be a 25 MHz clock. In one embodiment, the counters in the TDC can be zeroed by a synchronization signal (e.g., a single pulse) that is transmitted to DAQ circuitry unit (e.g., at startup). The synchronization signal ensures that the TDCs in all DAQ circuitry units share a common zero time, allowing for accurate coincidence pairing of events from different DAQ circuitry units.

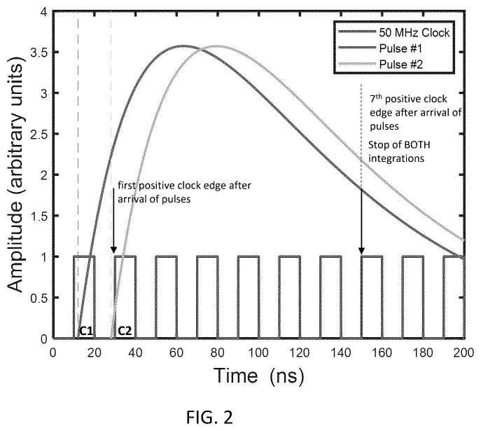

FIG. 2 is a timing diagram of an example integration window for two pulses. Integration of a pulse can be initiated when the amplitude of the pulse exceeds a certain threshold. In the system of FIG. 2, the expected integration window can be six clock cycles. The termination signal can be sent to the integrator at the seventh rising clock edge after the arrival of the pulses. Since the initiation signal generated by the comparator is asynchronous (not tied to a clock edge), it is possible that the integrator can begin integrating the signal during a clock cycle rather than at a rising or falling edge. Therefore, the actual length of the integration window can vary between signals, resulting in inaccurate relative energy measurements.

As illustrated in FIG. 2, integration of a first pulse can begin shortly after a rising edge of a first clock cycle C1. Integration of a second pulse can begin shortly before a rising edge of a second clock cycle C2. The rising edge of the second clock cycle C2 is the first rising edge after the start of integration for both the first pulse and the second pulse. The integration of both the first pulse and the second pulse will therefore terminate at the same time, e.g., at the seventh rising clock edge following the second clock cycle C2. The first pulse is integrated over a longer window because of the lag between the beginning of the first pulse and the nearest rising edge (of clock cycle C2) following the beginning of the first pulse.

Further variation in integration time can occur when a photodetector pulse is received during the setup and hold period of a digital clock signal. The setup period can be a period of time directly preceding a rising edge of a clock during which data that is held by the circuitry must remain stable. Any input or change to data stored in the circuitry during the setup period may be lost. When a photodetector signal and corresponding initiation signal is received during the setup period of the digital logic clock cycle, the digital logic circuitry may not register the initiation of integration until after the rising edge of the clock cycle. This delay can result in additional prolongation of the integration window. In one embodiment, the variation resulting from the setup and hold period can be approximately 10% of the clock period (e.g., 2 ns for a 50 MHz clock).

FIG. 2 is a timing diagram for a system that is triggered on the rising edge of a clock signal. In one embodiment, the circuitry described herein can be triggered on a falling edge. The integration window can be measured based on the rising edge, the falling edge, or a combination of rising and falling edges. FIG. 2 illustrates a digital logic clock having a 50% duty cycle. In one embodiment, the duty cycle of the clock (e.g., digital logic clock) can be greater than 50% or less than 50%.

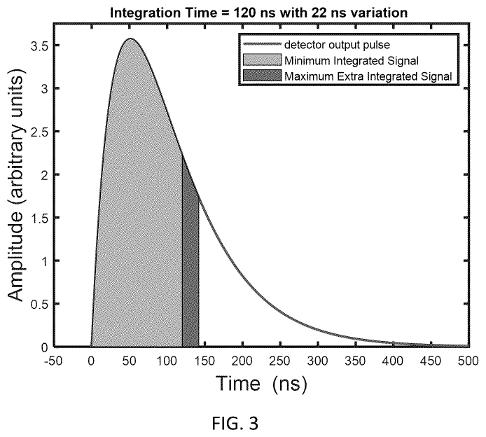

FIG. 3 is an illustration of minimum and maximum integration of a photodetector signal with DAQ circuitry having a 50 MHz clock. The integration window can be six full clock cycles, or 120 ns. When the initiation of integration is approximately aligned with the rising edge of a clock signal (e.g., arrival time of the photodetector signal at t=0), the photodetector signal can be integrated over a minimum of 120 ns, from approximately t=0 to t=120 ns. When the initiation of integration is not aligned with the rising edge of a clock signal, the photodetector signal can be integrated over a maximum of 142 ns rather than the expected 120 ns. The 142 ns integration window is a result of the six full clock cycles (120 ns), the delay as a result of the setup and hold period (up to 2 ns), and the lag between the beginning of the photodetector signal and the next nearest rising edge (up to one clock period, or 20 ns).

In one embodiment, the present disclosure is directed toward system and methods for correcting variation in integration window length based on the arrival time of the integration pulse. The arrival time of the integration pulse can be recorded by a TDC having a high-speed TDC clock. When the TDC clock is synchronized with the digital logic clock, an arrival time recorded by the TDC can be converted to a fractional relative phase of a digital logic clock cycle. For example, the digital logic clock can be a 50 MHz clock and the TDC clock can be an 800 MHz clock. An arrival time at t=8 clock cycles of an 800 MHz clock can correspond to an elapsed time of 10 ns after a synchronization signal. The synchronization signal can be received by all clocks in the system. The elapsed time of 10 ns is 50% of a period of a 50 MHz clock cycle, or a relative phase of 0.5. Generally, the relative phase (RelPhase) can be calculated as in Equation 1:

$$RelPhase = \frac{rem ( {t}_{arr} , {τ}_{D L} )}{{τ}_{D L}} \qquad Equation 1$$

Wherein tₐᵣᵣ is the arrival time and τ_{DL} is the period of the digital logic clock. The relative phase can be accurately and consistently determined for the system because the TDC clock and the digital logic clock are synchronized and in-phase. The relative phase can be between 0 and 1.

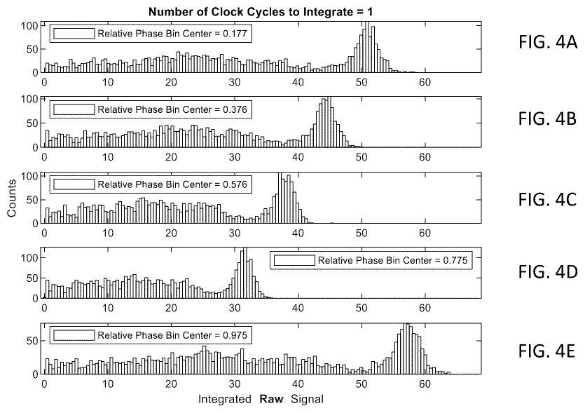

In one embodiment, the correction method of the present disclosure can include determining the energy of an integrated photodetector signal as a function of the relative phase of the arrival time of the photodetector signal. FIG. 4A through FIG. 4E are histograms showing integrated photodetector signal energy values for different arrival times. The integration window is 1 clock cycle. The integrated values (x-axis) can be digital data output by the digital logic of the DAQ circuitry 1. The digital data output can be a quantization of the analog energy value that is proportional to the total energy of the photodetector signal. The position of the peak in each histogram can correspond to the 511 keV energy of a photon. The photodetector signals can be acquired using Na²² as the radioactive tracer. In one embodiment, the integrated energy can be calculated for many thousands of photodetector signals in order to generate histograms of energy values for many relative phases.

FIG. 4A is a histogram of integrated energy values for photodetector signals that arrive at a relative phase of 0.177. The photodetector signals are integrated over a window of approximately 1.823 clock cycles. FIG. 4B is a histogram of integrated energy values for photodetector signals that arrive at a relative phase of 0.376. The photodetector signals are integrated over a window of approximately 1.624 clock cycles. FIG. 4C is a histogram of integrated energy values for photodetector signals that arrive at a relative phase of 0.576. The photodetector signals are integrated over a window of approximately 1.424 clock cycles. FIG. 4D is a histogram of integrated energy values for photodetector signals that arrive at a relative phase of 0.775. The photodetector signals are integrated over a window of 1.225 clock cycles. FIG. 4E is a histogram of integrated energy values for photodetector signals that arrive at a relative phase of 0.975. In one embodiment, the arrival time of the photodetector signals in FIG. 4E is within the setup and hold period of the digital logic clock. In this case, the digital logic clock does not begin measuring the integration window until after the setup and hold period, resulting in the photodetector signals being integrated over a window that is longer than the actual time between the arrival time and the second positive edge. In one embodiment, the integration window can be close to or exceeding two full clock cycles.

FIG. 4A through FIG. 4E illustrate the indirect relationship between the relative phase of the arrival time and the position of the integrated energy value peak. As the relative phase increases, the position of the peak shifts to the left. The delay caused by the setup and hold period results in a discontinuity in the relationship, wherein a high relative phase (e.g., over 0.9) corresponds with a high integrated energy value, as illustrated in FIG. 4E.

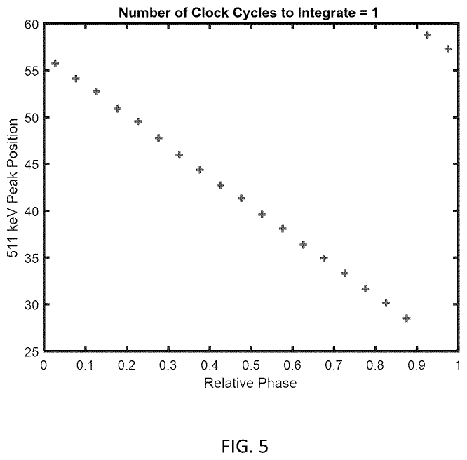

FIG. 5 is a graph of integrated energy value peak positions for photodetector signals arriving at different relative phases. The graph illustrates the approximately indirect relationship between the relative phase and the peak position from a relative phase of 0 to a relative phase of approximately 0.9. The graph further illustrates that a relative phase between approximately 0.9 and 1 can result in a higher peak position. In one embodiment, the relationship between the relative phase of the arrival time and the peak position before and after the discontinuity can be an approximately linear relationship.

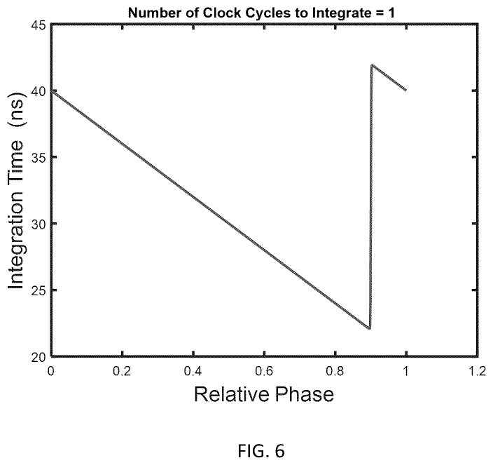

FIG. 6 is a graph of the relationship between the relative phase of the arrival time and the total integration time (actual length of an integration window). As the relative phase increases, the arrival time is closer to an initial rising edge that is considered the “start” of the integration window by the digital logic circuitry. Therefore, the total integration time decreases and is closer to a single period of the digital logic clock (e.g., 20 ns for a 50 MHz clock). Similarly, after the discontinuity, the total integration time decreases as the relative phase approaches 1. In one embodiment, the discontinuity can be modeled as a logistic approximation of the Heaviside step function,

$$H ( x ) = \frac{1}{1 + {e}^{- 2 x / k}} .$$

The function approaches an infinitely fast transition as k approaches 0, as illustrated in FIG. 6. In one embodiment, the relationship illustrated in FIG. 6 can be defined by Equation 2:

$$Integration Time = N * {τ}_{Int} + {τ}_{Int} * ( 1 - RelPhase ) + {τ}_{Int} * \frac{1}{1 + {e}^{- 2 ( R e l P h a s e - R e l P h a s e T ransition ) / k}} \qquad Equation 2$$

Wherein N is the desired number of clock cycles in an integration window, Tint is the period of the integrator clock, RelPhaseTransition is the relative phase transition point at which the discontinuity occurs, and k is the estimated transition width. In one embodiment, the transition point can be set to 0.9. In one embodiment, Equation 2 can include more than one discontinuity. For example, a second discontinuity can exist when the integration time is measured according to the rising and falling edges of the clock. In one embodiment, the second discontinuity can be modeled by the Heaviside function H(x) with the same or different parameters.

In one embodiment, the relationship between integration time and peak position can be approximated via linear regression, e.g.,

$$PeakPosition = ( IntegrationTime ( RelPhase ) - MeanIntegrationTime ) * m + b \qquad Equation 3$$

wherein m is the rate of change in peak position per change in integration time (slope) and b is the peak position when the integration time is equal to the mean integration time. The integration time can be determined based on the relative phase via Equation 2. In one embodiment, the mean integration time can be the expected integration window, e.g., an amount of time corresponding to a number of clock cycles. It can be appreciated that the relationship between peak position and integration time is not limited to a linear function, and that higher order functions or more complex functions (e.g., exponential) can also be used to characterize the integration.

The values of m and b for a given PET detector can be determined by characterizing photodetector signals received by the PET detector. For example, the energy of a number of photodetector signals having different arrival times can be measured via integration. The integrated energy values and the relative phases of the photodetector signals can form a system of linear equations that can be solved to determine the parameters of Equation 3, e.g.,

$$[ \begin{matrix}IntegrationTime ( {RelPhase}_{1} ) - MeanIntegrationTime & 1 \\ IntegrationTime ( {RelPhase}_{2} ) - MeanIntegrationTime & 1 \\ … & …\end{matrix} ] [ \begin{matrix}m \\ b\end{matrix} ] = [ \begin{matrix}{PeakPosition}_{1} \\ {PeakPosition}_{2} \\ …\end{matrix} ] \qquad Equation 4$$

The system of linear equations can be solved to determine m and b. In one embodiment, the system of linear equations can be solved via least squares regression. Equation 3 can then be used to determine a correction of integrated energy of a given photodetector signal when the relative phase of the photodetector signal is known. For example, the relative phase can be converted into a total integration time via Equation 2. The difference between the total integration time and the mean integration time (“excess” integration time) can be converted to a predicted peak position via Equation 3, wherein the predicted peak position corresponds to an amount of energy (“excess” energy) that is integrated during the excess integration time. The integrated energy can then be corrected (normalized, calibrated) to predict the energy value that would result during the expected integration window (e.g., a fixed number of clock cycles) without the excess integration time. In this manner, each integrated energy can be corrected to eliminate variation that occurs due to the nature of digital clocking.

In one embodiment, a corrected integrated energy (Corr_Eᵢ) can be calculated from an integrated energy (Eᵢ) and a relative phase by Equation 5:

$${Corr\_E}_{i} = \frac{{E}_{i}}{\begin{matrix}1 + \frac{m}{b} * [ IntegrationTime ( R e l P h a s {e}_{i} ) - \\ MeanIntegrationTime ]\end{matrix}} \qquad Equation 5$$

In one embodiment, the corrected integrated energy can further be scaled by a constant scaling factor to set the peak position, e.g., 511 keV. In one embodiment, the correction calculation can be applied by the DAQ circuitry 1 (e.g., the digital logic circuitry). In one embodiment, the DAQ circuitry 1 (e.g., the digital logic circuitry) can determine the relative phase of a photodetector signal and can output the relative phase to a second device (e.g., a computer). The second device can apply the correction calculation to the integrated energy based on the relative phase.

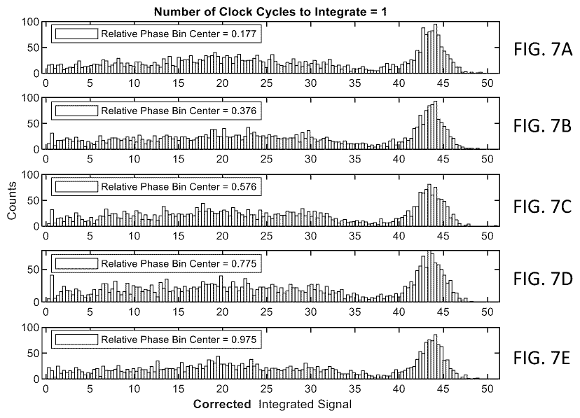

FIG. 7A through FIG. 7E are histograms showing corrected integrated energy values for photodetector signals having different arrival times. The peak (most frequent energy value) of each relative phase is in the same position, indicating that the photodetector signals had approximately the same integrated energy after correction. The peaks are also more uniform in shape/distribution. In one embodiment, the histogram peaks can correspond to 511 keV photodetector signals of interest resulting from annihilation events. The alignment of the peaks can restore the overall energy resolution of the PET detector.

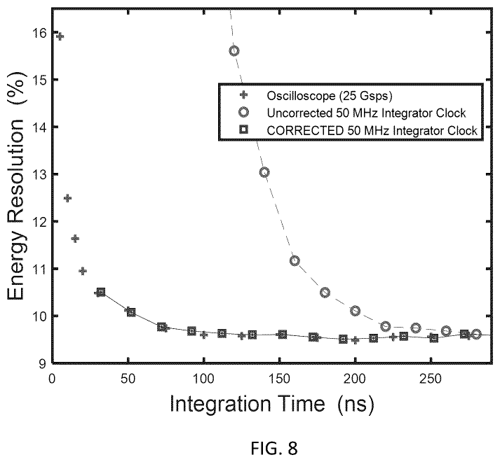

FIG. 8 is an illustration of energy resolution of a PET detector with and without energy correction. The energy resolution can be measured as a percentage of the full width half maximum value (FWHMV) of a peak at an energy level (e.g., 511 keV). The integration time for the corrected integrator clock values can be an average integration time corresponding to a number of clock cycles, while the integration time for the uncorrected integrator clock values can be the actual integration time (e.g., including fractions of a clock cycle). The energy resolution of the system with correction is similar to the energy resolution as measured with an oscilloscope, indicating more accurate recovery of photodetector signal energy.

In one embodiment, a photosensor can exhibit a non-linear response such that the signal energy is not linearly related to a number of detected optical photons. In one embodiment, a non-linearity correction can be applied to the photodetector signal in order to calculate an energy resolution of the system. In one embodiment, the correction of Equation 5 can be applied to photodetector signals to align the peaks with or without a non-linearity correction.

The parameters used to correct the integrated energy of a photodetector signal can be referred to herein as calibration parameters. The calibration parameters can include at least one of m, b, parameters used to model the discontinuity in integration time resulting from the setup and hold period, and any other variables disclosed herein. In one embodiment, the calibration parameters can be determined during a calibration phase. The calibration phase can include acquiring photodetector signal data including integrated energy values (Et) for a plurality of photodetector signals having different arrival times (t) and relative phases of arrival. The photodetector signal data can be used to determine the calibration parameters, e.g., m, b. In one embodiment, the calibration parameters can correspond to a given PET detector. In one embodiment, the calibration parameters can correspond to a PET detector scan session. In one embodiment, the calibration parameters can be generalized for a plurality of PET systems. The calibration phase can be followed by a correction phase. In the correction phase, the calibration parameters can be applied via Equation 5 to generate corrected integrated energy values (Corr_Eᵢ).

In one embodiment, the calibration parameters can include RelPhaseTransition, the transition point at which the discontinuity in integration time resulting from the setup and hold period occurs. RelPhaseTransition can be determined during the calibration phase. In one embodiment, an optimal RelPhaseTransition can be a value that minimizes a target function. The value can be determined using a minimization method such as a direct-search method, e.g., the Nelder-Mead simplex algorithm. In one embodiment, the minimization method can include varying RelPhaseTransition while other calibration parameters such as m and b are fixed.

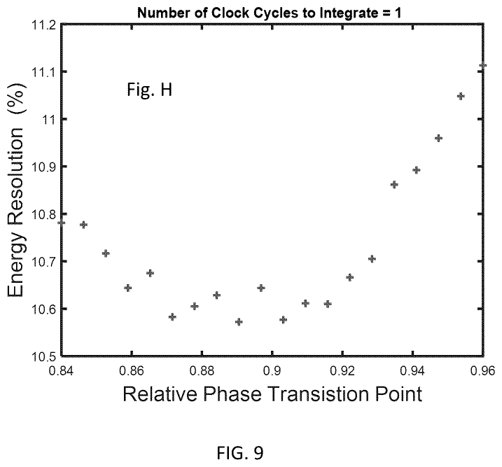

In one embodiment, the target function can be the calculation of energy resolution at 511 keV. Minimization of energy resolution can result in a more accurate PET system. In one embodiment, a non-linearity correction can be applied as needed in order to accurately calculate energy resolution. FIG. 9 is a graph of energy resolution as a function of RelPhaseTransition for fixed m and b values. RelPhaseTransition can be estimated to be approximately 0.9 (90%); therefore, variation during the minimization method can be within a range surrounding 0.9. In one embodiment, the variation of RelPhaseTransition can have a small effect on the energy resolution because only a relatively small proportion of photodetector signals are affected by the discontinuity at a high relative phase. The effect on energy resolution can also be offset by statistical uncertainty in curve-fitting the data points of FIG. 9.

In one embodiment, the target function can be the inverse of the number of measurement events wherein the integrated energy falls within a range of the full energy peak. The range can be, for example, within 5%. Ranges greater or less than within 5% are also compatible. The inverse value decreases as the number of measurement events within 5% accuracy (as an example) increases. Therefore, minimizing the inverse value can be a useful way to optimize RelPhaseTransition to increase the accuracy of integrated energy measurement.

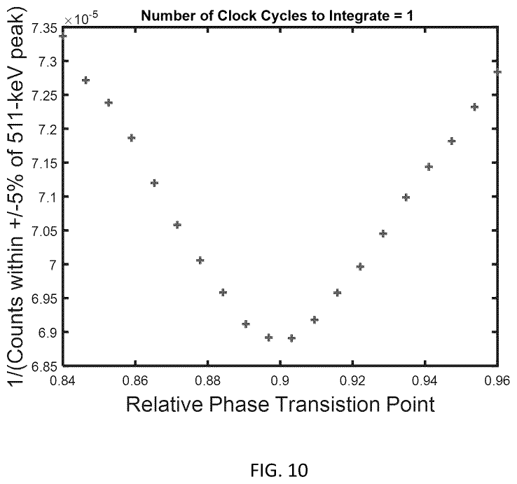

FIG. 10 is a graph of said inverse function as a target function of RelPhaseTransition. The inverse function can have a distinct minimum, e.g., at approximately 0.9. The RelPhaseTransition value that minimizes the target function can be determined in the calibration phase and then used to calculate RelPhase for photodetector signals in the correction phase.

In one embodiment, the calibration parameters can include the estimated transition width k of Equation 2. In one embodiment, k can be determined in the calibration phase as a value that minimizes a target function. In one embodiment, the target function can be the inverse function illustrated in FIG. 10.

In one embodiment, the methods described herein can include correcting for time walk in determining the arrival time of a photodetector signal. Variation in the amplitude and shape of the photodetector signal can result in variation in the time at which a photodetector signal passes a threshold that triggers the comparator to transmit the initiation signal. In one embodiment, time walk can be corrected based on corrected integrated energy Corr_Eᵢ. In one embodiment, correction of time walk can include determining time walk parameters. For example, time walk parameters can describe a relationship between time walk and corrected integrated energy. A second correction (time walk correction) can then be applied to Corr_Eᵢ according to the time walk parameters.

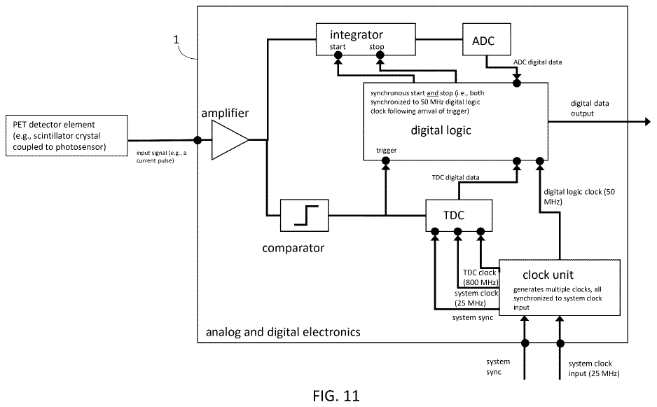

FIG. 11 is a schematic of a data acquisition (DAQ) circuitry unit 1 of a PET system, according to one embodiment. In one embodiment, the digital logic circuitry of the PET system can transmit the initiation pulse in addition to the termination pulse. The start of integration is thereby synchronized to the digital logic clock rather than being asynchronous (as in FIG. 1). In this manner, the actual length of the integration window is fixed because the integration can only begin at the rising or falling edge of a clock cycle of the digital logic clock. In contrast, integration in the system of FIG. 1 can begin in the middle of a digital logic clock cycle because the comparator can send the initiation pulse to the integrator independently of the digital logic circuitry.

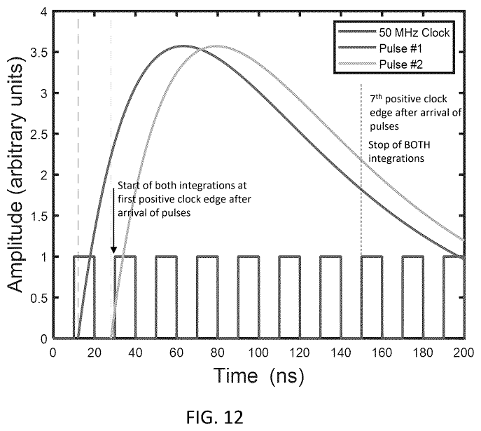

An issue that can arise when the initiation signal is sent by the digital logic circuitry is that integration of a photodetector signal can begin at varying points in the photodetector signal. FIG. 12 is a timing diagram of an example integration window for two pulses when the initiation pulse is transmitted by the digital logic circuitry. The pulses can arrive at different times that are approximately 1 full clock cycle apart. However, the integration of both pulses begins at the same time (approximately t=30 ns). The initial rise of the first pulse is not captured by the integration from t=30 ns, while the initial rise of the second pulse is captured by the integration from t=30 ns. As a result, the integrated energy of the first pulse can be inaccurate. The amount of energy that is excluded from integration can be a function of the arrival time (e.g., relative phase) of the pulse.

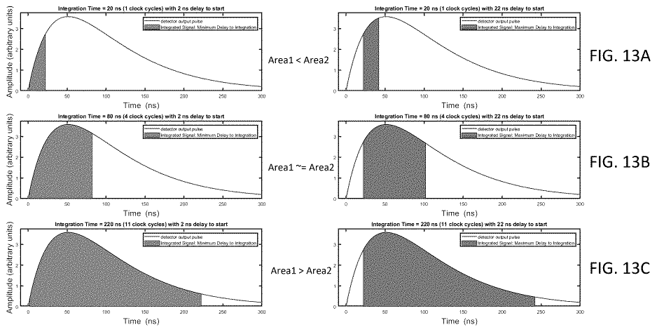

FIG. 13A through FIG. 13C are illustrations of minimum and maximum delays in integration for fixed integration windows. In FIG. 13A, the integration window can be 1 clock cycle (e.g., 20 ns for a 50 MHz digital logic clock). A minimum delay can occur when the arrival time of the photodetector signal (as determined by the comparator and TDC) occurs directly before a rising edge of the digital logic clock. The digital logic circuitry can transmit the initiation pulse at the nearest rising edge of the digital logic clock, which is approximately at the beginning of the photodetector signal. A maximum delay can occur when the arrival time of the photodetector signal (as determined by the comparator and TDC) occurs directly after a rising edge of the digital logic clock. The digital logic circuitry can transmit the initiation pulsing at the nearest rising edge of the digital logic clock. However, the nearest rising edge is approximately one clock cycle after the arrival time of the photodetector signal. As a result, a portion of the photodetector signal that is nearer to the peak of the photodetector signal is integrated over 1 clock cycle, resulting in the integrated energy being greater in the maximum delay case compared to the minimum delay case.

In FIG. 13B, the integration window can be 4 clock cycles (e.g., 80 ns for a 50 MHz digital logic clock). In this case, the integrated energy of the photodetector signal with minimum and maximum delay can be approximately equal. However, the integrated energy may not be equal for different waveforms or amplitudes. In FIG. 13C, the integration window can be 11 clock cycles (e.g., 220 ns for a 50 MHz clock). In this case, the integrated energy of the photodetector signal in the minimum delay case is greater than in the maximum delay case. In general, the integrated energy can vary based on the interplay between the pulse shape, the length of the integration window, and the digital logic clock frequency.

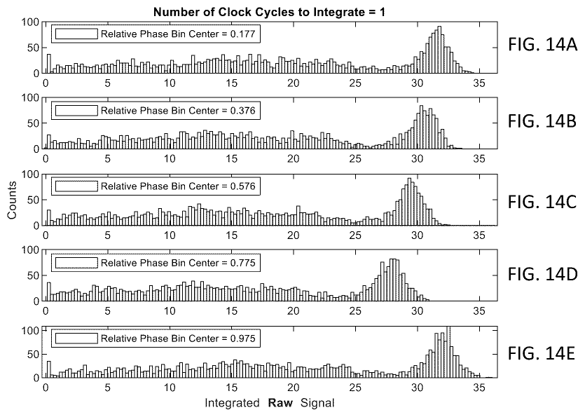

In one embodiment, the variation in the integrated region of the photodetector signal can be minimized or eliminated by determining a relationship between the arrival time of the photodetector signal and the integrated energy of the photodetector signal. FIG. 14A through FIG. 14E are histograms showing integrated photodetector signal energy values for different relative phases of arrival times with a synchronized integration window of 1 clock cycle. The integrated values can be digital data output by the digital logic of the DAQ circuitry. The digital data output can be a quantization of the analog energy value that is acquired by integrating the photodetector signal over time and is therefore proportional to the total energy of the photodetector signal. The position of the peak in the histogram can correspond to the 511 keV energy of a photon. The photodetector signals can be acquired using Na²² as the radioactive tracer. In one embodiment, the integrated energy can be calculated for many thousands of photodetector signals in order to generate histograms of energy values for many phases.

FIG. 14A is a histogram of integrated energy values for photodetector signals that arrive at a relative phase of 0.177. FIG. 4B is a histogram of integrated energy values for photodetector signals that arrive at a relative phase of 0.376. FIG. 4C is a histogram of integrated energy values for photodetector signals that arrive at a relative phase of 0.576. FIG. 4D is a histogram of integrated energy values for photodetector signals that arrive at a relative phase of 0.775. FIG. 4E is a histogram of integrated energy values for photodetector signals that arrive at a relative phase of 0.975. In one embodiment, the arrival time of the photodetector signals in FIG. 4E is within the setup and hold period of the digital logic clock. In this case, the digital logic circuitry does not register the arrival of the photodetector signal and transmit the initiation pulse until after the setup and hold period.

FIG. 14A through FIG. 14E illustrate the indirect relationship between the relative phase of the arrival time and the position of the integrated energy value peak. When the photodetector signal arrives earlier in a digital logic clock cycle, a larger portion of the initial rise of the photodetector signal is excluded during integration, resulting in the integration window being closer to the peak of the photodetector signal. As the relative phase increases, the peak of the photodetector signal shifts to the left. The delay caused by the setup and hold period results in a discontinuity in the relationship, wherein a high relative phase (e.g., over 0.9) corresponds with a high integrated energy value, as illustrated in FIG. 4E. In one embodiment, the discontinuity can be a high-to-low discontinuity, wherein a high relative phase corresponds with a low integrated energy value. The discontinuity can be a function of the photodetector signal waveform and the clock frequency.

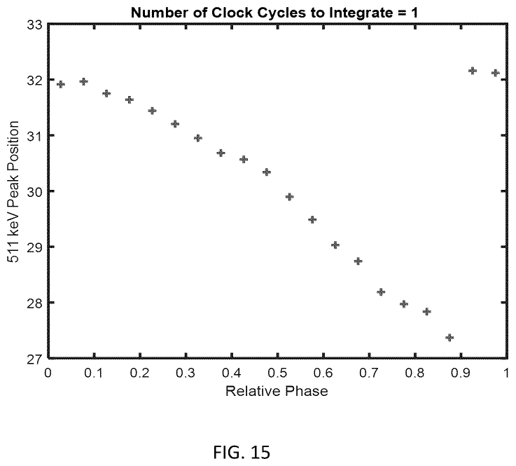

FIG. 15 is a graph of integrated energy value peak positions for photodetector signals arriving at different relative phases. The relative phase of the arrival time for the photodetector signals can be calculated using Equation 1. The graph illustrates the approximately indirect relationship between the relative phase and the integrated energy from a relative phase of 0 to a relative phase of approximately 0.9. The graph further illustrates that a relative phase between approximately 0.9 and 1 can result in a higher peak position. In one embodiment, the relationship between the relative phase of the arrival time and the peak position before and after the discontinuity can be an approximately linear relationship.

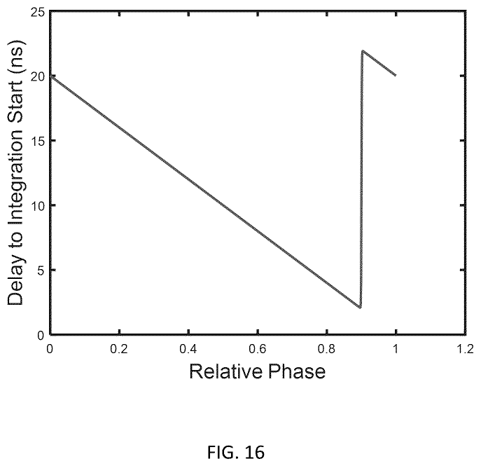

FIG. 16 is a graph of the relationship between the relative phase of the arrival time and delay in the start of integration. The delay can be the time difference between the arrival time of the photodetector signal and the initiation of integration. As the relative phase increases, the arrival time is closer to an initial rising edge that is considered the “start” of the integration window by the digital logic circuitry. Therefore, the delay to integration start decreases and approaches 0. Similarly, after the discontinuity, the total integration time decreases as the relative phase approaches 1. In one embodiment, the discontinuity can be modeled as a logistic approximation of the Heaviside step function,

$$H ( x ) = \frac{1}{1 + {e}^{- 2 x / k}} .$$

The function approaches an infinitely fast transition as k approaches 0, as illustrated in FIG. 16. In one embodiment, the relationship can be defined by Equation 6:

$$Delay = {τ}_{Int} * ( 1 - RelPhase ) + {τ}_{Int} * \frac{1}{1 + {e}^{- 2 ( R e l P h a s e - R e l P h a s e T ransition ) / k}} \qquad Equation 6$$

Wherein τ_{Int} is the period of the integrator, RelPhaseTransition is the relative phase transition point at which the discontinuity occurs, and k is the estimated transition width. In one embodiment, the integrator can share the digital logic clock. In one embodiment, the transition point can be set to 0.9.

In one embodiment, the relationship between delay and peak position can be approximated via linear regression, e.g.,

$$PeakPosition = ( Delay ( RelPhase ) - MeanDelay ) * m + b \qquad Equation 7$$

wherein m is the rate of change in peak position per change in delay time (slope) and b is the peak position when the delay time is equal to the mean delay time. In one embodiment, the mean delay time can be a percentage of the period of the digital logic clock, e.g., approximately 10%. The calibration parameters can include the values of m and b. It can be appreciated that the relationship between delay and peak position is not limited to a linear function, and that higher order functions or more complex functions (e.g., exponential) can also be used to characterize the integration.

The values of m and b for a given PET detector can be determined by characterizing photodetector signals received by the PET detector. For example, the energy of a number of photodetector signals having different arrival times can be measured via integration. The arrival time can be converted to a delay in integration using Equation 6. The integrated energy values and the relative phases can form a system of linear equations that can be solved to determine a linear relationship between delay and peak position, e.g.,

$$[ \begin{matrix}Delay ( {RelPhase}_{1} ) - MeanDelay & 1 \\ Delay ( {RelPhase}_{2} ) - MeanDelay & 1 \\ … & …\end{matrix} ] [ \begin{matrix}m \\ b\end{matrix} ] = [ \begin{matrix}{PeakPosition}_{1} \\ {PeakPosition}_{2} \\ …\end{matrix} ] \qquad Equation 8$$

The system of linear equations can be solved to determine m and b. In one embodiment, the system of linear equations can be solved via least squares regression. The integrated energy can then be corrected (normalized, calibrated) to predict the energy value that would result if the photodetector signal were integrated from the start of the photodetector signal. In this manner, each integrated energy can be corrected to eliminate variation that occurs due to the nature of digital clocking. The peak position of integrated energy for identical photodetector signals (e.g., 511 keV peaks) will then be aligned.

In one embodiment, a corrected integrated energy (Corr_Eᵢ) can be calculated from an integrated energy (Eᵢ) and a relative phase by Equation 9:

$${Corr\_E}_{i} = \frac{{E}_{i}}{1 + \frac{m}{b} * [ Delay ( R e l P h a s {e}_{i} ) - M e a n D e l a y ]} \qquad Equation 9$$

In one embodiment, the corrected integrated energy can further be scaled by a constant scaling factor to set the peak position, e.g., 511 keV. In one embodiment, the correction calculation can be applied by the DAQ circuitry 1 (e.g., the digital logic circuitry). In one embodiment, the DAQ circuitry 1 (e.g., the digital logic circuitry) can determine the relative phase of a photodetector signal and can output the relative phase to a second device (e.g., a computer). The second device can apply the correction calculation to the integrated energy based on the relative phase.

In one embodiment, the relationship between delay and peak position can be a nonlinear relationship. For example, the relationship can include higher order terms, as in Equation 10:

$$PeakPosition = a * {( ΔD elay )}^{2} + b * ( Δ Delay ) + c \qquad Equation 10$$

Wherein ΔDelay=Delay (RelPhase)−MeanDelay. The calibration parameters can include the values of a, b, and c.

Equation 10 can be solved using a different system of linear equations, e.g.,

$$[ \begin{matrix}{( {Δ Delay}_{1} )}^{2} & {Δ Delay}_{1} & 1 \\ {( {Δ Delay}_{2} )}^{2} & {Δ Delay}_{2} & 1\end{matrix} ] [ \begin{matrix}a \\ b \\ c\end{matrix} ] = [ \begin{matrix}{PeakPosition}_{1} \\ {PeakPosition}_{2}\end{matrix} ] \qquad Equation 11$$

The system of linear equations can be solved to determine a, b, and c. In one embodiment, a corrected integrated energy (Corr_Eᵢ) can be calculated from an integrated energy (Eᵢ) and a relative phase by Equation 12:

$${Corr\_E}_{i} = \frac{{E}_{i}}{1 + \frac{a}{c} * {( {Δ Delay}_{i} )}^{2} + \frac{b}{c} * {Δ Delay}_{i}} \qquad Equation 12$$

In one embodiment, the corrected integrated energy can further be scaled by a constant scaling factor to set the peak position, e.g., 511 keV.

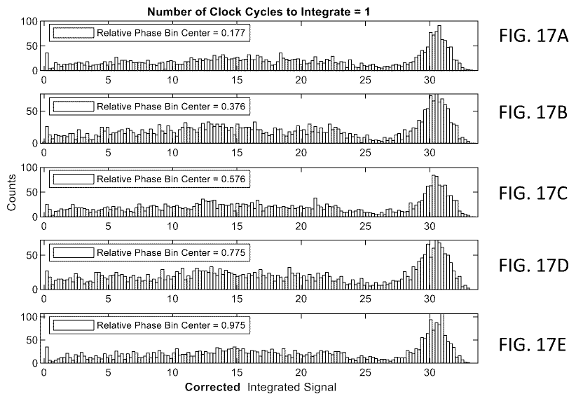

FIG. 17A through FIG. 17E are histograms showing corrected integrated photodetector signal energy values for different relative phases of arrival times. The peak (most frequent energy value) of each relative phase is in the same position, indicating that the photodetector signals forming the histogram peak had approximately the same integrated energy after correction. In one embodiment, the histogram peaks can correspond to 511 keV photodetector signals of interest resulting from annihilation events. The alignment of the peaks can restore the overall energy resolution of the PET detector.

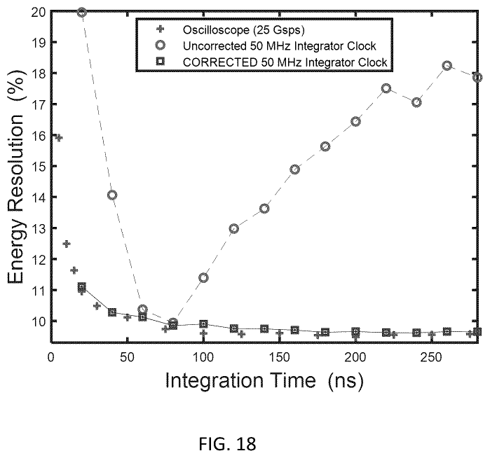

FIG. 18 is an illustration of energy resolution of a PET detector with and without energy correction for the delay in integration. The energy resolution can be measured as a percentage of the full width half maximum value (FWHMV) of a peak at an energy level (e.g., 511 keV). The energy resolution of the system with correction is similar to the energy resolution of an oscilloscope as the integration time increases, indicating more accurate recovery of photodetector signal energy.

In one embodiment, the calibration parameters for the PET detector of FIG. 11 can include parameters related to modeling the relationship between arrival time and delay, such as RelPhaseTransition, k, etc. These calibration parameters can be determined during a calibration phase as discussed herein and used to correct integrated energy values.

In one embodiment, one or more of the calibration parameters described herein can be determined using a machine learning model. For example, an artificial neural network (ANN) can be trained to model a relationship between the arrival time of a photodetector signal and an energy correction that can be applied to the photodetector signal. The ANN can be trained on acquired photodetector signal data described herein. The ANN can be useful for determining a more complex relationship between arrival time and integrated energy that accurately models experimental photodetector signal data. The ANN can include a system of one or more neural networks. For example, a first ANN can model the integration time (or delay) as a function of relative phase including any discontinuities. A second ANN can model the energy correction as a function of the integration time (or delay).

The systems and methods described herein can improve the accuracy of photodetector signal integration while maintaining low clock frequencies of digital logic circuitry. Since clock frequency is directly related to power consumption, the present disclosure can improve the energy resolution of a PET detector without increasing power and cooling requirements. The methods can also be applied to correct photodetector signal data without changing DAQ hardware configurations of existing PET detectors. The calibration parameters described herein can be determined specifically for a given PET detector, resulting in a more accurate correction.

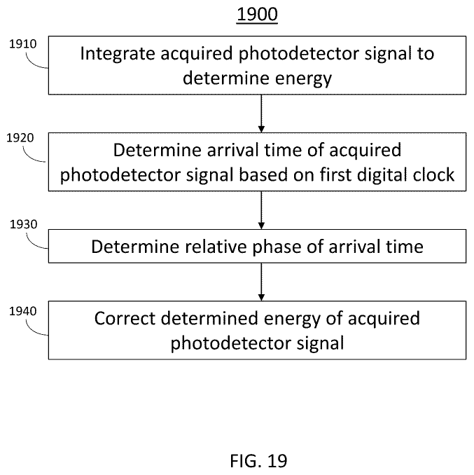

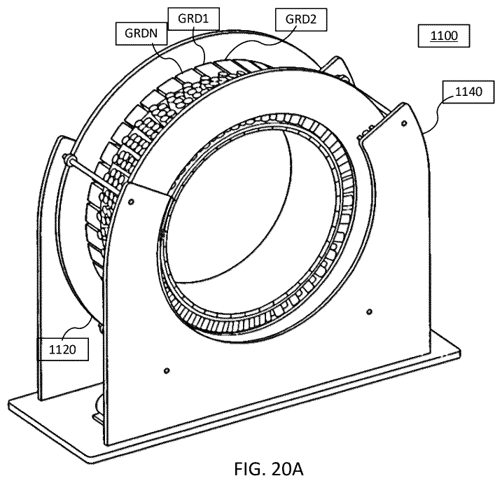

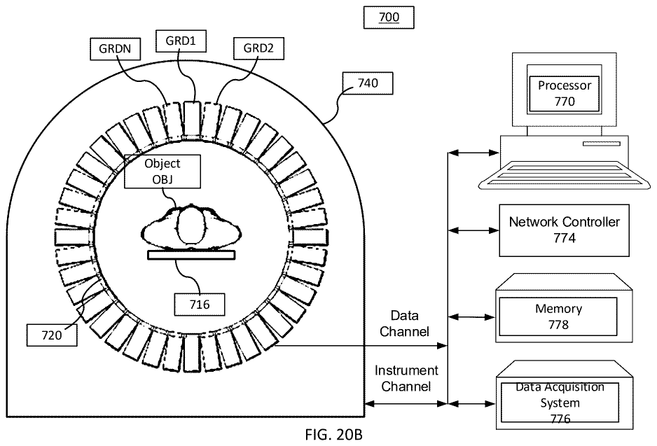

FIG. 19 is a flowchart of a method 1900 of performing energy correction of PET photodetector signals according to one embodiment. The method can be performed by the circuitry and hardware illustrated in FIG. 20B, for example. In step 1910, an acquired photodetector signal can be integrated over an integration window to determine an energy of the acquired photodetector signal. The integration window can be triggered by an initiation signal based on an amplitude of the photodetector signal. In one embodiment, the integration window can be defined by a number of clock cycles. The beginning of the integration window can be synchronous with the initiation signal or asynchronous with the initiation signal.

In step 1920, the arrival time of the acquired photodetector signal can be determined based on a first digital clock having a first clock frequency. The first digital clock can be, for example, the TDC clock having a first clock frequency of 800 MHz. In step 1930, the relative phase of the arrival time can be determined with respect to a second digital clock having a second clock frequency. The second digital clock can be, for example, a digital logic clock having a second clock frequency of 25 MHz. In one embodiment, the first digital clock and the second digital clock can be synchronized, e.g., with a phase-locked loop. In one embodiment, the first clock frequency can be greater than the second clock frequency.

In step 1940, the determined energy of the photodetector signal can be corrected based on one or more calibration parameters and the determined relative phase of the arrival time. The one or more calibration parameters can be parameters that are determined in a calibration process using a plurality of collected photodetector events. For example, the one or more calibration parameters can include parameters describing a relationship between the relative phase of the arrival time and an integrated energy of the photodetector signal.

The integration window can be initiated and/or terminated based on a digital clock. In one embodiment, the digital clock can be the second digital clock, e.g., the digital logic clock. In one embodiment, the one or more calibration parameters can include parameters describing a relationship between the relative phase of the arrival time and a length or delay in the integration window.

FIG. 20A and FIG. 20B show a non-limiting example of a PET scanner 700 that can implement the method 1900. The PET scanner 700 includes a number of gamma-ray detectors (GRDs) (e.g., GRD1, GRD2, through GRDN) that are each configured as rectangular detector modules. According to one implementation, the detector ring includes 40 GRDs. In another implementation, there are 48 GRDs, and the higher number of GRDs is used to create a larger bore size for the PET scanner 700.

Each GRD can include a two-dimensional array of individual detector crystals, which absorb gamma radiation and emit scintillation photons. The scintillation photons can be detected by a two-dimensional array of photomultiplier tubes (PMTs) that are also arranged in the GRD. A light guide can be disposed between the array of detector crystals and the PMTs.

Alternatively, the scintillation photons can be detected by an array of silicon photomultipliers (SiPMs), and each individual detector crystals can have a respective SiPM.

Each photodetector (e.g., PMT or SiPM) can produce an analog signal that indicates when scintillation events occur, and an energy of the gamma ray producing the detection event. Moreover, the photons emitted from one detector crystal can be detected by more than one photodetector, and, based on the analog signal produced at each photodetector, the detector crystal corresponding to the detection event can be determined using Anger logic and crystal decoding, for example.

FIG. 20B shows a schematic view of a PET scanner system having gamma-ray (gamma-ray) photon counting detectors (GRDs) arranged to detect gamma-rays emitted from an object OBJ. The GRDs can measure the timing, position, and energy corresponding to each gamma-ray detection. In one implementation, the gamma-ray detectors are arranged in a ring, as shown in FIG. 20A and FIG. 20B. The detector crystals can be scintillator crystals, which have individual scintillator elements arranged in a two-dimensional array and the scintillator elements can be any known scintillating material. The PMTs can be arranged such that light from each scintillator element is detected by multiple PMTs to enable Anger arithmetic and crystal decoding of scintillation event.

FIG. 20B shows an example of the arrangement of the PET scanner 700, in which the object OBJ to be imaged rests on a table 716 and the GRD modules GRD1 through GRDN are arranged circumferentially around the object OBJ and the table 716. The GRDs can be fixedly connected to a circular component 720 that is fixedly connected to the gantry 740. The gantry 740 houses many parts of the PET imager. The gantry 740 of the PET imager also includes an open aperture through which the object OBJ and the table 716 can pass, and gamma-rays emitted in opposite directions from the object OBJ due to an annihilation event can be detected by the GRDs and timing and energy information can be used to determine coincidences for gamma-ray pairs.

In FIG. 20B, circuitry and hardware are also shown for acquiring, storing, processing, and distributing gamma-ray detection data. The circuitry and hardware include: a processor 770, a network controller 774, a memory 778, and a data acquisition system (DAS) 776. The PET imager also includes a data channel that routes detection measurement results (e.g., the digital data output from the DAQ circuitry 1) from the GRDs to the DAS 776, the processor 770, the memory 778, and the network controller 774. The DAS 776 can control the acquisition, digitization, and routing of the detection data from the detectors. In one implementation, the DAS 776 controls the movement of the bed 716. The processor 770 performs functions including reconstructing images from the detection data, pre-reconstruction processing of the detection data, and post-reconstruction processing of the image data, as discussed herein. The processor 770 can perform the determination of calibration parameters in the calibration phase and/or application of energy correction in the correction phase.

The processor 770 can be configured to perform various steps of the methods described herein and variations thereof. The processor 770 can include a CPU that can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog, or any other hardware description language and the code may be stored in an electronic memory directly within the FPGA or CPLD, or as a separate electronic memory. Further, the memory may be non-volatile, such as ROM, EPROM, EEPROM or FLASH memory. The memory can also be volatile, such as static or dynamic RAM, and a processor, such as a microcontroller or microprocessor, may be provided to manage the electronic memory as well as the interaction between the FPGA or CPLD and the memory.

Alternatively, the CPU in the processor 770 can execute a computer program including a set of computer-readable instructions that perform various steps of the methods described herein, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xenon processor from Intel of America or an Opteron processor from AMD of America and an operating system, such as Microsoft VISTA, UNIX, Solaris, LINUX, Apple, MAC-OS and other operating systems known to those skilled in the art. Further, CPU can be implemented as multiple processors cooperatively working in parallel to perform the instructions.

The memory 778 can be a hard disk drive, CD-ROM drive, DVD drive, FLASH drive, RAM, ROM or any other electronic storage known in the art.

The network controller 774, such as an Intel Ethernet PRO network interface card from Intel Corporation of America, can interface between the various parts of the PET imager. Additionally, the network controller 774 can also interface with an external network. As can be appreciated, the external network can be a public network, such as the Internet, or a private network such as an LAN or WAN network, or any combination thereof and can also include PSTN or ISDN sub-networks. The external network can also be wired, such as an Ethernet network, or can be wireless such as a cellular network including EDGE, 3G, 4G, and 5G wireless cellular systems. The wireless network can also be WiFi, Bluetooth, or any other wireless form of communication that is known.

The order of discussion of the different steps as described herein has been presented for clarity's sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Numerous modifications and variations of the present disclosure are possible in light of the above teachings. It is therefore to be understood that within the scope of the appended claims, the invention may be practiced otherwise than as specifically described herein.

1. A method of performing an energy correction of positron emission tomography (PET) photodetector signals, the method comprising:
integrating an acquired photodetector signal over an integration window to determine an energy of the acquired photodetector signal;
determining an arrival time of the acquired photodetector signal based on a first digital clock having a first clock frequency;
determining a relative phase of the determined arrival time with respect to a second digital clock having a second clock frequency; and
correcting the determined energy of the acquired photodetector signal based on one or more calibration parameters and the determined relative phase of the arrival time to determine a corrected energy of the acquired photodetector signal, wherein
the one or more calibration parameters are determined in a calibration process using a plurality of collected photodetector events.

2. The method of claim 1, wherein the first digital clock is synchronized with the second digital clock, and the first clock frequency is greater than the second clock frequency.

3. The method of claim 1, wherein the integrating step further comprises terminating the integration window based on the second digital clock.

4. The method of claim 1, wherein the correcting step further comprises correcting the determined energy using the one or more calibration parameters, which describe a linear relationship between the determined relative phase of the arrival time and the determined energy of the acquired photodetector signal.

5. The method of claim 1, wherein the correcting step further comprises correcting the determined energy using the one or more calibration parameters, which describe a quadratic relationship between the determined relative phase of the arrival time and the determined energy of the acquired photodetector signal.

6. The method of claim 1, further comprising determining a length of the integration window based on the determined relative phase of the arrival time, and correcting the determined energy of the acquired photodetector signal based on the determined length of the integration window.

7. The method of claim 6, wherein the correcting step further comprises correcting the determined energy using the one or more calibration parameters, which describe a relationship between the determined relative phase of the arrival time and the length of the integration window.

8. The method of claim 1, wherein the integrating step further comprises initiating the integration window based on the second digital clock.

9. The method of claim 8, further comprising determining a delay between the determined arrival time of the acquired photodetector signal and a start time of the integration window based on the determined relative phase of the arrival time, and correcting the determined energy of the acquired photodetector signal based on the determined delay.

10. The method of claim 9, wherein the correcting step further comprises correcting the determined energy using the one or more calibration parameters, which describe a relationship between the determined relative phase of the arrival time and the determined delay.

11. The method of claim 1, further comprising determining the one or more calibration parameters using a trained artificial neural network.

12. A positron emission tomography (PET) apparatus, comprising:
a first digital clock having a first clock frequency;
a second digital clock synchronized with the first digital clock and having a second clock frequency greater than the first clock frequency; and
processing circuitry configured to
integrate an acquired photodetector signal over an integration window to determine an energy of the acquired photodetector signal,
determine an arrival time of the acquired photodetector signal based on the first digital clock,
determine a relative phase of the determined arrival time with respect to the second digital clock, and
correct the determined energy of the acquired photodetector signal based on one or more calibration parameters and the determined relative phase of the arrival time to generate a corrected energy of the acquired photodetector signal, wherein
the one or more calibration parameters are determined in a calibration process using a plurality of collected photodetector events.

13. The apparatus of claim 12, wherein the processing circuitry is further configured to terminate the integration window based on the second digital clock.

14. The apparatus of claim 12, wherein the processing circuitry is further configured to determine a length of the integration window based on the determined relative phase of the arrival time and correct the determined energy of the acquired photodetector signal based on the determined length of the integration window.

15. The apparatus of claim 14, wherein the processing circuitry is configured to correct the determined energy based on the one or more calibration parameters, which describe a relationship between the determined relative phase of the arrival time and the determined length of the integration window.

16. The apparatus of claim 12, wherein the processing circuitry is further configured to determine a delay between the determined arrival time of the acquired photodetector signal and a start time of the integration window based on the determined relative phase of the arrival time, and correct the determined energy of the acquired photodetector signal based on the determined delay.

17. The apparatus of claim 16, wherein the processing circuitry is configured to correct the determined energy based on the one or more calibration parameters, which describe a relationship between the determined relative phase of the arrival time and the determined delay.

18. The apparatus of claim 12, wherein the processing circuitry is configured to determine the one or more calibration parameters using a trained artificial neural network.

19. A non-transitory computer-readable storage medium for storing computer readable instructions that, when executed by a computer, cause the computer to perform a method, the method comprising:
receiving a determined energy of an acquired photodetector signal and an arrival time of the acquired photodetector signal based on a first digital clock having a first clock frequency;
determining a relative phase of the arrival time with respect to a second digital clock having a second clock frequency; and
correcting the determined energy of the photodetector signal based on one or more calibration parameters and the determined relative phase of the photodetector signal to determine a corrected energy of the photodetector signal, wherein
the one or more calibration parameters are determined in a calibration process using a plurality of collected photodetector events.

20. The non-transitory computer-readable storage medium of claim 19, wherein the correcting step further comprises correcting the determined energy using the one or more calibration parameters, which describe a linear relationship or a quadratic relationship between the determined relative phase of the arrival time and the determined energy of the acquired photodetector signal.
